(19) United States
(12) Patent Application Publication
(10) Pub. No.: US 2024/0274429 A1
(43) Pub. Date: Aug. 15, 2024

(54) Methods and Systems for Injecting Ions into an Electrostatic Linear Ion Trap

(71) Applicant: DH Technologies Development Pte. Ltd., Singapore (SG)

(72) Inventor: Eric Thomas DZIEKONSKI, Concord (CA)

(21) Appl. No.: 18/568,417

(22) PCT Filed: Jun. 9, 2022
(86) PCT No.: PCT/IB2022/055380

§ 371 Date: Dec. 8, 2023

Related U.S. Application Data
(60) Provisional application No. 63/209,171, filed on Jun. 10, 2021.

(51) Int. Cl. H01J 49/42; H01J 49/00; H01J 49/02; H01J 49/06

(52) U.S. Cl. CPC H01J 49/4245; H01J 49/0009; H01J 49/0031; H01J 49/027; H01J 49/065; H01J 49/4255; H01J 49/426

(57) ABSTRACT

Systems and methods described herein provide for the injection of ions into an ELIT at a variety of kinetic energies such that the ions turn around at various locations. In certain aspects, such systems and methods for operating an ELIT may reduce ion density at the turning points to reduce the impact of the space charge effect. Various aspects of the present teachings also provide for the design or optimization of the ELIT electrode spacing and/or injection potentials to reduce the impact of the space charge effect. In some related aspects, the ELIT may additionally provide time-focusing of the various ion groups at the detector as they oscillate along their respective path lengths.

### FIELD

The present teachings generally relate to methods and systems for analyzing ions using an electrostatic linear ion trap (ELIT).

### BACKGROUND

Mass spectrometry is an analytical technique for measuring the mass-to-charge ratios (m/z) of molecules within a sample, with both quantitative and qualitative applications. For example, mass spectrometry can be used to identify unknown compounds in a test substance, determine the isotopic composition of elements in a specific molecule, determine the structure of a particular compound by observing its fragmentation, and/or quantify the amount of a particular compound in a test sample.

Mass spectrometry typically involves converting the sample molecules into ions using an ion source and separating and detecting the ionized molecules based on their m/z using one or more mass analyzers. For most conventional mass spectrometer systems utilizing atmospheric pressure ion sources, ions pass through an inlet orifice to enter an ion guide disposed in a first vacuum chamber where they are collisionally cooled and radially focused along the central axis of the ion guide, and then transported as an ion beam into a subsequent, lower-pressure vacuum chamber in which the mass analyzer(s) are disposed.

An electrostatic linear ion trap (ELIT) is a mass analyzer in which ions are confined along an axis between electrode ion mirrors (reflectrons), typically on opposite sides of a central pickup electrode. The average kinetic energy (average velocity) of ions within the ELIT is typically fixed by the injection method, electrode geometries, and trapping potentials. As a result, ions in the ELIT oscillate back and forth along the axis from end to end with a mass-to-charge ratio (m/z) specific average velocity. Ion oscillation between the reflectrons generates an electric current, the frequency of which can be used to calculate the m/z of the trapped ions as follows:

$${f}_{ion} = \frac{k}{\sqrt{m / z}} + b$$

where k and b are experimentally determined constants. In this manner, the charge induced on the pickup electrode may be digitized and subject to Fourier transform (FT) to calculate the mass spectrum. An example of a known ELIT is described, for example, by Dziekonski et al. in a paper entitled “Voltage-induced frequency drift correction in Fourier transform electrostatic linear ion trap mass spectrometry using mirror-switching” as published in the International Journal of Mass Spectrometry 410:12-21 (2016), the teachings of which are hereby incorporated by reference in their entirety.

PCT Pub. No. WO2020/121166, which is also incorporated by reference in its entirety, describes another example ELIT that can be alternatively operated to analyze a wide m/z range with low resolution or a narrower m/z range with higher resolution. Wherein the axial length of an ELIT is inversely related to FT resolution for a fixed acquisition time and ion kinetic energy (e.g., a longer oscillation path length results in a lower oscillation frequency), PCT Pub. No. WO2020/121166 provides a system that can set the oscillation path length through the selective application of voltages to the various electrodes of the ELIT to alternately provide a longer oscillation path length (e.g., for a relatively wide m/z range, low resolution ELIT analysis) or a shorter oscillation path length (e.g., for a relatively narrow m/z range, high resolution ELIT analysis). Such a system allows a user to select parameters of the ELIT analysis for all ions injected into the trap without, for example, requiring two or more ELITs having different analysis parameters running in parallel (e.g., requiring duplication of parts) or without breaking vacuum to physically replace the ELIT with a different ELIT having a different configuration of reflectrons (e.g., requiring downtime and skilled labor).

There remains a need for improved methods and systems for analyzing ions using an electrostatic linear ion trap (ELIT).

### SUMMARY

The performance of mass analyzers may be affected by the interaction of the charged ions therewithin. Known as the space charge effect, the force of repulsion among nearby ions may perturb the ions' trajectories causing ions to diverge from their typical oscillation velocities or frequencies within an ELIT, for example, potentially reducing the accuracy of ELIT analysis. Moreover, the analytical impact of the space charge effect is dependent on ion velocity and charge density. For example, the space charge effect is more pronounced on the trajectory of slower moving ions and when there are increased number of ions in a smaller space. Because all of the ions oscillating within a conventional ELIT are injected substantially simultaneously with substantially identical injection energies, the injected ions tend to turn around at substantially the same axial positions within the ELIT due to the electric potentials applied to the reflectrons. At such common turning points, however, ion velocity within the ELIT is at a minimum, thereby amplifying the space charge effect on the ions' trajectory. In accordance with various aspects of the present teachings, the systems and methods described herein may provide for the injection of ions at different kinetic energies to vary the oscillation end points between the ions to be analyzed by the ELIT. By providing different path lengths within an ELIT, certain aspects of the applicant's teachings may be effective to reduce the ion density when ion velocity is at a minimum, thereby reducing the impact of the space charge effect relative to the operation of conventional systems incorporating an ELIT.

In various aspects, a mass spectrometer system in accordance with the present teachings comprises an electrostatic linear ion trap (ELIT) having a first set of electrode plates having holes in the center and aligned along a central axis and a second set of electrode plates having holes in the center and aligned along the central axis. A first group of plates of the first and second sets is positioned along the central axis to trap a first group of ions therebetween within a first path length along the central axis and a second group of plates of the first and second sets is positioned along the central axis to simultaneously trap a second group of ions within a second path length of the central axis that is different than the first path length. The system may further comprise one or more ion traps disposed upstream of the ELIT and configured to inject the first and second groups of ions therein, wherein the one or more ion traps are configured to inject the first group of ions into the ELIT within a first range of kinetic energy and to inject the second group of ions from the ion trap into the ELIT within a second range of kinetic energy, wherein the first and second ranges of kinetic energy are different.

In certain related aspects, the first group of ions and the second group of ions may exhibit substantially the same m/z range. Additionally, in some example aspects, the system may be configured such that ions of the same m/z in the first and second groups of ions arrive at a location between the first and second sets of electrode plates at substantially the same time during their respective oscillation along the first and second path lengths.

In various aspects, the first range of kinetic energy may be selected such that the first group of ions exhibits a first frequency of oscillation along the first path length and the second range of kinetic energy may be selected such that the second group of ions exhibits a second frequency of oscillation along the second path length. In certain related aspects, the first and second frequencies of oscillation may be substantially identical.

ELITs utilized in systems in accordance with the present teachings can comprise more than two groups of plates defining first and second path lengths. By way of non-limiting example, the ELIT may comprise three, four, or even more groups of nested electrodes defining various path lengths. In certain example aspects, a third group of plates of the first and second sets may be positioned along the central axis to trap a third group of ions therebetween within a third path length along the central axis that is different than the first and second path lengths. Moreover, the one or more ion traps may be configured to inject the third groups of ions into the ELIT within a third range of kinetic energy that is different than the first and second ranges of kinetic energy. Additionally, the ELIT may comprise a fourth group of plates of the first and second sets positioned along the central axis to trap a fourth group of ions therebetween within a fourth path length along the central axis that is different than the first, second, and third path lengths, with said one or more ion traps being configured to inject the fourth groups of ions into the ELIT within a fourth range of kinetic energy that is different than the first, second, and third ranges of kinetic energy. The first, second, third, and fourth groups of ions may comprise ions having the same or different ranges of m/z.

In various aspects, the system may further comprise a controller operative coupled to various elements of the mass spectrometer system. By way of example, in certain aspects, a controller may be provided that is configured to adjust at least one of the first range of kinetic energy, the second range of kinetic energy, a potential applied to the first group of plates, and a potential applied to the second group of plates to minimize differences in an oscillation frequency of the first and second groups of ions along their respective first and second path lengths. Additionally, in certain related aspects, the controller may be further configured to adjust at least one of the first range of kinetic energy, the second range of kinetic energy, the potential applied to the first group of plates, and the potential applied to the second group of plates to minimize a difference in time at which ions of the same m/z in the first and second groups of ions arrive at a location between the first and second sets of electrode plates during oscillation of the first and second groups of ions along their respective first and second path lengths.

In accordance with various aspects of the present teachings, a method of analyzing ions is provided comprising transmitting a first group of ions exhibiting a first range of kinetic energy and a second group of ions exhibiting a second range of kinetic energy different from the first range of kinetic energy from one or more ion traps to an electrostatic ion trap (ELIT), the ELIT comprising a first set of electrode plates having holes in the center and aligned along a central axis and a second set of electrode plates having holes in the center and aligned along the central axis. The method may further comprise trapping the first group of ions between a first group of plates of the first and second sets positioned along the central axis within a first path length along the central axis. Concurrent with trapping the first group of ions, the second group of ions may be trapped between a second group of plates of the first and second sets positioned along the central axis within a second path length along the central axis that is different than the first path length. The method may further comprise detecting an electric current induced by the first group of ions oscillating along the first path length and the electric current induced by the second group of ions oscillating along the second path length.

In various aspects, the first group of ions and the second group of ions may exhibit substantially the same m/z range. In some related example aspects, ions of the same m/z in the first and second groups of ions may arrive at a location between the first and second sets of electrode plates at substantially the same time during their respective oscillation along the first and second path lengths.

In various aspects, the first range of kinetic energy may be selected such that the first group of ions exhibits a first frequency of oscillation along the first path length and the second range of kinetic energy may be selected such that the second group of ions exhibits a second frequency of oscillation along the second path length. In certain related aspects, the first and second frequencies of oscillation may be substantially identical.

In various aspects, the method of analyzing ions may be performed wherein the ELIT further comprises: a third group of plates of the first and second sets having holes in the center and aligned along the central axis; and a fourth group of plates of the first and second sets having holes in the center and aligned along the central axis. In such aspects, the method may further comprise trapping a third group of ions exhibiting a third range of kinetic energy between the third group of plates defining a thrid path length and trapping a fourth group of ions exhibiting a fourth range of kinetic energy between the fourth group of plates defining a fourth path length.

In various aspects, methods in accordance with the present teachings may further comprise adjusting at least one of the first range of kinetic energy, the second range of kinetic energy, a potential applied to the first group of plates, and a potential applied to the second group of plates to minimize differences in an oscillation frequency of the first and second groups of ions along their respective first and second path lengths. In certain related aspects, at least one of the first range of kinetic energy, the second range of kinetic energy, the potential applied to the first group of plates, and the potential applied to the second group of plates may be adjusted to minimize a difference in time at which ions of the same m/z in the first and second groups of ions arrive at a location between the first and second sets of electrode plates during oscillation of the first and second groups of ions along their respective first and second path lengths.

In accordance with various aspects of the present teachings, a method of configuring an electrostatic ion trap (ELIT) is provided, the method comprising generating a model ELIT based on a physical ELIT having a first set of electrode plates having holes in the center and aligned along a central axis and a second set of electrode plates having holes in the center and aligned along the central axis. An initial simulated electric potential respectively applied to each of a plurality of simulated electrodes of the model ELIT may be determined, wherein each of the plurality of simulated electrodes represents one of the first set of electrode plates and the second set of electrode plates. The method may further comprise simulating an injection of a simulated ion at a plurality of kinetic energies into the model ELIT in which the initial simulated electric potentials are respectively applied to each of the plurality of simulated electrodes, and for each of the plurality of kinetic energies, determining the predicted frequency of oscillation of said simulated ion between at least two of the plurality of simulated electrodes of the model ELIT. Further, the method may comprise determining whether the predicted frequency of oscillation for said simulated ion at each of the plurality of kinetic energies is within a predefined range of the average predicted frequency of oscillation across the plurality of kinetic energies. In a case in which the predicted frequency of oscillation for said simulated ion at each of the plurality of kinetic energies is within the predefined range, the method may comprise configuring the physical ELIT such that each of the electrode plates of the first and second sets corresponding to each of the plurality of simulated electrodes have said initial simulated electric potential respectively applied thereto. In a case in which the predicted frequency of oscillation for said simulated ion for at least one of the plurality of kinetic energies is outside of the predefined range, the method may comprise iteratively adjusting the simulated electric potential applied to one or more of the plurality of simulated electrodes of the model ELIT until the predicted frequency of oscillation for said simulated ion at each of the plurality of kinetic energies is within the predefined range of the average predicted frequency of oscillation across the plurality of kinetic energies, and configuring the physical ELIT such that each of the electrode plates of the first and second sets corresponding to the each of the plurality of simulated electrodes of the model ELIT have said adjusted simulated electric potential respectively applied thereto.

In various example aspects, the method may further comprise injecting at least a first group of ions and a second group of into the physical ELIT, wherein each of the first and second groups of ions exhibit a different injection kinetic energy; and concurrently trapping the first group of ions between a first group of plates of the first and second sets within a first path length along the central axis and the second group of ions between a second group of plates of the first and second sets positioned within a second path length along the central axis that is different than the first path length. In certain aspects, the first group of ions oscillate along the first path length and the second group of ions oscillate along the second path length at substantially the same frequency. Further, in some additional aspects, ions of the same m/z in the first and second groups of ions arrive at a location between the first and second sets of electrode plates at substantially the same time during their respective oscillation along the first and second path lengths.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1 schematically an exemplary mass spectrometer system in accordance with an aspect of various embodiments of the applicant's teachings.

FIG. 2 is a schematic representation of the ELIT of FIG. 1 in additional detail in accordance with an aspect of various embodiments of the applicant's teachings.

FIG. 3 is a schematic representation of the ELIT of FIG. 2 in which the inner group of electrodes are activated to trap ions in accordance with an aspect of various embodiments of the applicant's teachings.

FIG. 4 is a schematic representation of the ELIT of FIG. 2 in which the inner and outer group of electrodes are activated to trap two groups of ions injected with different injection energies in accordance with an aspect of various embodiments of the applicant's teachings.

FIG. 5 is a flowchart showing an example method for operating the ELIT of FIG. 1 in accordance with an aspect of various embodiments of the applicant's teachings.

FIG. 6 is a block diagram that illustrates a computer system, upon which embodiments of the present teachings may be implemented in accordance with various aspects of the applicant's teachings.

FIG. 7 depicts the calculated electric field strength along the axis of a mathematical example model ELIT in accordance with various aspects of the applicant's teachings.

FIG. 8 depicts a corresponding SIMION model of the mathematical ELIT model utilized to generate the plot of FIG. 7 in accordance with various aspects of the applicant's teachings.

FIG. 9 is a plot of expected time deviation of the turn-around time for ions injected into the example SIMION model ELIT of FIG. 8 in accordance with various aspects of the applicant's teachings.

FIG. 10 is a plot of the expected oscillation frequency of an ion injected into the example SIMION model ELIT in accordance with various aspects of the applicant's teachings.

FIG. 11 is a plot of the expected oscillation frequency of an ion injected into an optimized example SIMION model ELIT of FIG. 8.

FIG. 12 schematically depicts the injection of ions into an ELIT in accordance with various aspects of the applicant's teachings.

FIG. 13 schematically depicts the injection of ions into an ELIT in accordance with various aspects of the applicant's teachings.

FIG. 14 schematically depicts the injection of ions into an ELIT in accordance with various aspects of the applicant's teachings.

FIGS. 15A-C depict optimizing the selection of injection energies for the example model ELIT of FIG. 8.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also not be discussed in any great detail for brevity. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

Systems and methods in accordance with various aspects of the present teachings apply trapping potentials to different groups of electrodes within an ELIT such that multiple groups of ions injected with different injection energies may be simultaneously trapped and analyzed as the groups of ions oscillate along different, respective path lengths within the ELIT. In various aspects, the present teachings provide for the selection of the potentials applied to the electrodes of the ELIT and/or the selection of the injection energies applied to the various groups of ions so as to provide different turning points for the multiple groups of ions along the axis of the ELIT.

Whereas conventional systems utilizing an ELIT typically inject all of the ions subject to analysis into the ELIT with substantially the same kinetic energies such that the oscillating ions turn around at approximately the same location, various aspects of the present teachings provide for the injection of ions at a variety of kinetic energies such that the ions turn around at various locations, thereby reducing ion density when ion velocity is at a minimum. Various aspects of the present teachings also provide for the design or optimization of the ELIT electrode spacing and/or injection potentials to reduce the impact of the space charge effect. In some related aspects, the ELIT may additionally provide time-focusing of the various ion groups at the detector as they oscillate along their respective path lengths.

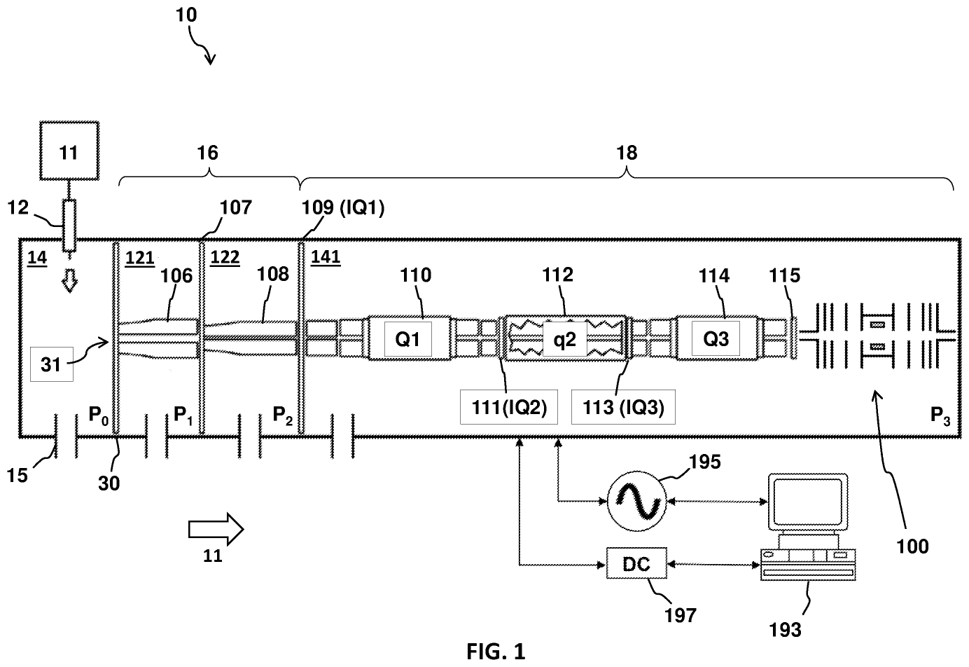

FIG. 1 schematically depicts an embodiment of an exemplary mass spectrometry system 10 having an ELIT 100 for mass analyzing ions in accordance with various aspects of the applicant's teachings. As shown, the exemplary mass spectrometer system 10 can comprise an ion source 12 for generating ions within an ionization chamber 14, an upstream section 16, and a downstream section 18. The upstream section 16 is configured to perform initial processing of ions received from the ion source 12, and includes various elements such as a curtain plate 30 and one or more ion guides 106, 108. The downstream section 18 includes one or more mass analyzers 110 and 114 (also referred to herein as Q1 and Q3, respectively), a collision cell 112, and an ELIT 100. As shown, for example, the system 10 includes an RF power supply 195 and DC power supply 197 that can be controlled by a controller 193 so as to apply electric potentials having RF, AC, and/or DC components to the various components of the system 10. For example, as discussed otherwise herein, the controller 193 may control the RF and/or DC signals applied to one or more upstream ion traps and/or the ELIT 100 so as to inject a plurality of groups of ions into the ELIT 100 at various ranges of kinetic energies such that the groups of ions simultaneously oscillate within the ELIT 100 along different path lengths.

The ion source 12 can be any known or hereafter developed ion source for generating ions and modified in accordance with the present teachings. Non-limiting examples of ion sources suitable for use with the present teachings include atmospheric pressure chemical ionization (APCI) sources, electrospray ionization (ESI) sources, continuous ion source, a pulsed ion source, an inductively coupled plasma (ICP) ion source, a matrix-assisted laser desorption/ionization (MALDI) ion source, a glow discharge ion source, an electron impact ion source, a chemical ionization source, or a photo-ionization ion source, among others. Additionally, as shown in FIG. 1, the system 10 can include a sample source 11 configured to provide a sample to the ion source 12. The sample source 11 can be any suitable sample inlet system known in the art. By way of example, the ion source 12 can be configured to receive a fluid sample from a variety of sample sources, including a reservoir containing a fluid sample that is delivered to the sample source (e.g., pumped), a liquid chromatography (LC) column, a capillary electrophoresis device, and via an injection of a sample into a carrier liquid. In the example depicted in FIG. 1, the ion source 12 comprises an electrospray electrode, which can comprise a capillary fluidly coupled to the sample source 11 (e.g., through one or more conduits, channels, tubing, pipes, capillary tubes, etc.), and which terminates in an outlet end that at least partially extends into the ionization chamber 14 to discharge the liquid sample therein.

One or more power supplies can supply power to the ion source 12 with appropriate voltages for ionizing the analytes in either positive ion mode (analytes in the sample are protonated, generally forming the cations to be analyzed) or negative ion mode (analytes in the sample are deprotonated, generally forming the anions to be analyzed). Further, the ion source 12 can be nebulizer-assisted or non-nebulizer assisted. In some embodiments, ionization can also be promoted with the use of a heater, for example, to heat the ionization chamber so as to promote dissolution of the liquid discharged from the ion source.

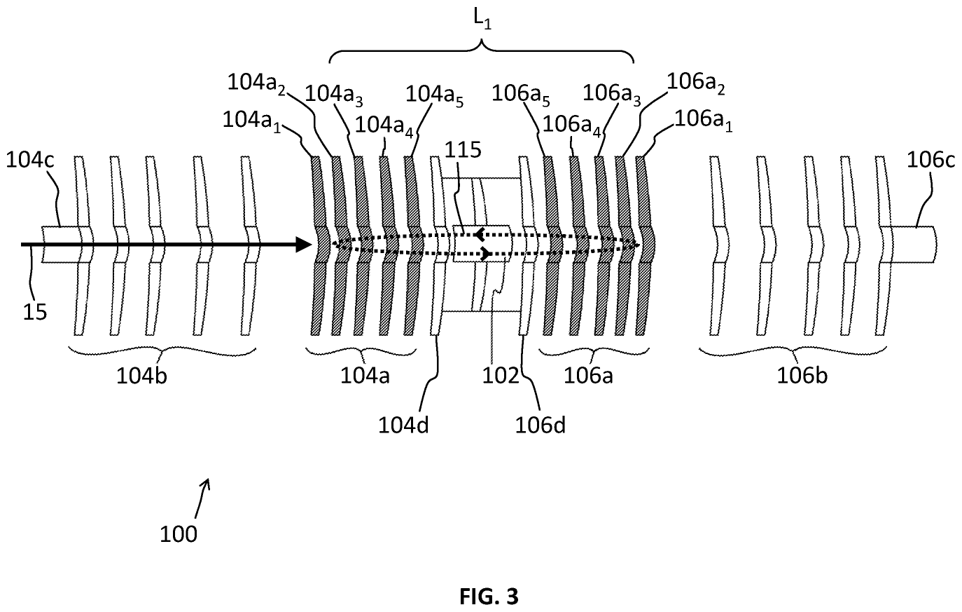

With continued reference to FIG. 1, the analytes, contained within the sample discharged from the ion source 12, can be ionized within the ionization chamber 14, which is separated from the upstream section 16 by the curtain plate 30. The curtain plate 30 can define a curtain plate aperture 31, which is in fluid communication with the upstream section 16. Although not shown in FIG. 3, the system 10 can include various other components. For example, the system 10 can include a curtain gas supply (not shown) that provides a curtain gas flow (e.g., of N₂) to the upstream section 16 of the system 10. The curtain gas flow can aid in keeping the downstream section 18 of the mass spectrometer system 10 clean (e.g., by de-clustering and evacuating large neutral particles). For example, a portion of the curtain gas can flow out of the curtain plate aperture 31 into the ionization chamber 14, thereby preventing the entry of droplets and/or neutral molecules through the curtain plate aperture 31.

The ions generated by the ion source 12 generally travel towards the vacuum chambers 121, 122, 141, in the direction indicated by the arrow 11 in FIG. 1. Initially, these ions can be successively transmitted through the elements of the upstream section 16 (e.g., curtain plate 30, ion guide 106, and ion guide 108) to result in a narrow and highly focused ion beam (e.g., along the central longitudinal axis of the system 10) for further m/z-based analysis within the downstream portion 18. The ions generated by the ion source 12 enter the upstream section 16 to traverse one or more intermediate vacuum chambers 121, 122 and/or ion guides 106, 108 having elevated pressures greater than the high vacuum chamber 141 within which the mass analyzers are disposed. As shown, for example, the ions traverse the ion guide 106 (also referenced herein as “QJet”), which provides collisional cooling and radial focusing of the ions into an ion beam using a combination of gas dynamics and radio frequency fields. The ion guide 106 transfers the ions through an exit aperture in the ion lens 107 to subsequent ion optics such as ion guide 108 (also referenced herein as “Q0”) through an ion lens 107 (also referenced herein as “IQ0”). The ion guide Q0 108 can be an RF ion guide and can comprise a quadrupole rod set. This ion guide Q0 108 can be positioned in a second vacuum chamber 122 and so as to transport ions through an intermediate pressure region prior to delivering ions through the subsequent optics (e.g., IQ1 lens 109) to the downstream section 18 of system 100.

The ionization chamber 14 can be maintained at a pressure P₀, which can be atmospheric pressure or a substantially atmospheric pressure. However, in some embodiments, the ionization chamber 14 can be evacuated to a pressure lower than atmospheric pressure. The pressure (P₁) of the vacuum chamber 121 can be maintained at a pressure ranging from approximately 100 mTorr to approximately 50 Torr, although other pressures can be used for this or for other purposes. For example, in some aspects, the first vacuum chamber 121 can be maintained at a pressure above about 100 mTorr. In certain implementations, the first vacuum chamber can be maintained at a pressure in a range from about 0.5 Torr to about 10 Torr. Alternatively or additionally, the first vacuum chamber can be maintained at a pressure ranging from about 10 Torr to about 50 Torr. Similarly, vacuum chamber 122 can be evacuated to a pressure (P₂) that is lower than that of first vacuum chamber 121 (i.e., P₁). For example, the second vacuum chamber 122 can be maintained at a pressure of about 3 to 15 mTorr, although other pressures can be used for this or for other purposes.

Ions traversing the quadrupole rod set Q0 108 pass through the lens IQ1 109 and into the adjacent quadrupole rod set Q1 110 in the downstream section 18, which can be situated in a vacuum chamber 141 that can be evacuated to a pressure (P₃) that can be maintained lower than that of the ion guide 106 chamber 121 and the ion guide Q0 108 chamber 122. For example, the vacuum chamber 141 can be maintained at a pressure less than about 1×10−4 Torr or lower (e.g., about 5×10⁻⁵ Torr), though other pressures can be used for this or for other purposes. As will be appreciated by a person of skill in the art, the quadrupole rod set Q1 110 can be operated as a conventional transmission RF/DC quadrupole mass filter that can be operated to select an ion of interest and/or a range of ions of interest. For example, the quadrupole rod set Q1 110 can be provided with RF/DC voltages suitable for operation in a mass-resolving mode (e.g., by one or more voltage supplies 195/197). As should be appreciated, taking the physical and electrical properties of mass analyzer Q1 110 into account, parameters for an applied RF and DC voltage can be selected so that Q1 110 establishes a transmission window of chosen m/z ratios, such that these ions can traverse Q1 110 largely unperturbed. Ions having m/z ratios falling outside the window, however, do not attain stable trajectories within the quadrupole and can be prevented from traversing the quadrupole rod set Q1 110. It should be appreciated that this mode of operation is but one possible mode of operation for Q1 110. By way of example, the lens IQ2 111 between Q1 110 and collision cell q2 112 can be maintained at a much higher offset potential than Q1 110 such that the quadrupole rod set Q1 110 can be operated as an ion trap. In such a manner, the potential applied to the entry lens IQ2 111 can be selectively lowered (e.g., mass selectively scanned) such that ions trapped in Q1 110 can be accelerated into collision cell q2 112, which could also be operated as an ion trap, for example.

Ions traversing the quadrupole rod set Q1 110 can pass through the lens IQ2 111 and into the adjacent quadrupole rod set q2 112, which as shown can be disposed in a pressurized compartment and can be configured to operate as a collision cell at a pressure approximately in the range of from about 1 mTorr to about 10 mTorr, though other pressures can be used for this or for other purposes. A suitable collision gas (e.g., nitrogen, argon, helium, etc.) can be provided by way of a gas inlet (not shown) to thermalize and/or fragment ions in the ion beam. By way of example, in MS/MS, the quadrupole rod set Q1 110 can be operated to transmit to q2 112 precursor ions exhibiting a selected range of m/z for fragmentation into product ions within q2 112. In MS mode, the parameters for RF and DC voltages applied to the rods of q2 112 can be selected so that q2 transmits these ions therethrough largely unperturbed.

Ions that are transmitted by quadrupole rod set q2 112 can pass into the adjacent quadrupole rod set Q3 114, which is bounded upstream by IQ3 113 and downstream by the exit lens 115. As will be appreciated by a person skilled in the art, the quadrupole rod set Q3 114 can be operated at a decreased operating pressure relative to that of collision cell q2 112, for example, less than about 1×10−4 Torr (e.g., about 5×10⁻⁵ Torr), though other pressures can be used for this or for other purposes. As will be appreciated by a person skilled in the art, quadrupole rod set Q3 114 can be operated in a number of manners, for example, as a scanning RF/DC quadrupole, as a linear ion trap, or as a RF-only ion guide to allow the ions to pass therethrough unperturbed. Following processing or transmission through Q3 114, the ions can be transmitted into the ELIT 100 through the exit lens 115. The ELIT 100 can then be operated to analyze the ions as discussed herein.

A person skilled in the art will appreciate in light of the present teachings that one or more of the depicted example mass analyzers (e.g., Q1 rod set 110 and Q3 rod set 114) may be effective to release groups of ions trapped within the one or more mass analyzers such that they arrive at the ELIT 100 with different kinetic energies as discussed below. By way of non-limiting example, the quadrupole rod set Q1 110 and/or the quadrupole rod set Q3 114 can trap and release a first group of ions exhibiting a first kinetic energy range (e.g., based on the offset potentials applied to the quadrupole rods of Q3 and the exit lens 115), and subsequently while the first group of ions are oscillating within the ELIT 100, trap and release a second group of ions exhibiting a second kinetic energy range that is different than the first range. It will be appreciated, for example, that adjusting the DC offset of the quadrupole rods (e.g., via the application of one or more control signals provided by controller 193 to the DC power supply 197) can cause the trapped ions to be ejected from Q1 110 and/or Q3 114 with a known kinetic energy once the exit barrier provided by the exit lens (e.g., TQ2 111 or exits lens 115) has been lowered. Taking into account the effect of any downstream elements, each group of ions can arrive at the ELIT 100 exhibiting a desired range of kinetic energies.

Indeed, a person skilled in the art will appreciate that any known mass analyzer(s) (e.g., one or more ion trap(s)) may be modified in view of the present teachings to inject a plurality of groups of ions into the ELIT 100 at various kinetic energies. By way of an additional non-limiting example, while the quadrupole rod set Q3 114 of FIG. 1 is discussed above comprising four continuous, quadrupole rods arranged around a central axis, the mass analyzer Q3 114 may be configured as a segmented ion trap providing a plurality (at least two) substantially discrete trapping regions, wherein the volume of the ion trap may be physically (and electrically) subdivided to trap ions in the one or more discrete trapping regions. By way of example, each quadrupole rod may be “segmented” such that various DC offset potentials may be applied thereto. In this manner, groups of ions may be cooled within each of the discrete regions of the quadrupole rod set and serially released therefrom upon the application of appropriate voltages to the elements of the ion trap. An example of a known segmented ion trap that can be modified in accordance with the present teachings is described, for example, in U.S. Pub. No. 200802108601, the teachings of which are incorporated by reference in its entirety.

Moreover, although, for convenience, the mass analyzers 110, 114 and collision cell 112 are described herein as being quadrupoles having elongated rod sets (e.g., having four rods), a person of ordinary skill in the art should appreciate that these elements can have other suitable configurations. For instance, it will be appreciated that the one or more mass analyzers 110, 114 can be any of triple quadrupoles, linear ion traps, quadrupole time of flights, Orbitrap or other Fourier transform mass spectrometers, all by way of non-limiting examples.

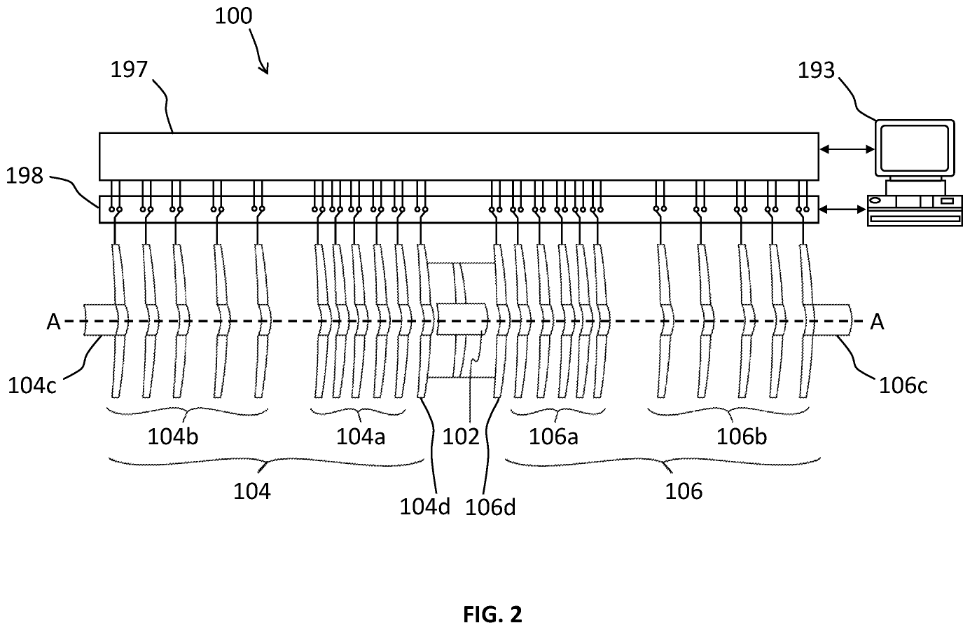

With reference now to FIG. 2, the example ELIT 100 in accordance with various aspects of the present teachings is depicted in additional detail. As shown, the ELIT 100 comprises a plurality of electrode plates 104, 106 and a detector 102 (e.g., a pickup electrode) for mass analyzing ions in accordance with various aspects of the applicant's teachings. The controller 193 is operably coupled to one or more voltage sources 197 and one or more switches 198 for controlling the potentials applied to the plurality of electrode plates during operation of the ELIT as discussed otherwise herein.

Each of the example electrode plates 104, 106 comprise a central opening through which a central axis (A) extends. Though the electrode plates of FIG. 1 are shown as generally planar and together represent a cylindrical structure, a skilled artisan would appreciate that the shape, size, and number of individual electrodes (and overall shape of the trap) can have a variety of configurations for controlling movement of the ions when performing ELIT in accordance with the present teachings. See e.g., Hogan, J. A. et al., “Optimized Electrostatic Linear Ion Trap for Charge Detection Mass Spectrometry,” J. Am. Soc. Mass Spectrom., 29:2086-2095 (2018), the teachings of which are hereby incorporated by reference in their entirety.

Generally, the plurality of the electrode plates are separated into two sets such that the ions can oscillate along the central axis between electrodes from each set. For example, as shown in FIG. 2, a first set 104 of electrode plates is disposed on one side of the detector 102 (e.g., the left side) and the second set 106 of electrode plates is disposed on the opposed side of the detector 102 (e.g., the right side). The detector 102 can have a variety of configuration but is generally used to measure the induced image current or image charge produced by the oscillating ions as discussed otherwise herein. It will be appreciated that while the detector 102 shown in FIG. 2 is generally described herein as a central pickup electrode, the detector 102 need not be disposed between the first and second sets 104, 106. Indeed, a person skilled in the art will appreciate that detection of the ion oscillation can be performed by the electrode plates themselves, using multiple electrodes, or other shaped electrodes, all by way of non-limiting example. In certain example aspects, at least two detectors may be provided, with the at least two detectors being represented by the depicted central pickup electrode 102, one or more plates of the first set 104, one or more plates of the second set 106, and combinations thereof. A Fourier transform (FT) may then be performed on the digitized signal measured by the detector 102 to obtain the oscillation frequency or frequencies, which as noted above is/are dependent on the m/z of the one or more oscillating ions such that the m/z of the oscillating ions can be calculated.

In accordance with various aspects of the present teachings, the electrode plates of the first and second sets 104,106 can be configured through the application of various electric potentials to generally operate as a nested electrostatic ion trap. That is, a first group of electrodes of the first and second set may operate as a first, inner trap defining a first path length for ion oscillation and a second group of electrodes surrounding the electrodes of the inner trap may operate as a second, outer trap defining a second, longer path length for coaxial ion oscillation. As shown in FIG. 2, for example, the first set 104 of electrode plates generally comprises plates 104a of a first group 104a/106a and plates 104b of a second group 104b/106b. Likewise, the second set 106 of electrode plates generally comprises plates 106a of the first group 104a/106a and plates of 106b of the second group 104b/106b. Together, the first group 104a/106a represents the inner electrodes in that they are disposed toward the center of the trap (i.e., toward detector 102) relative to the second group 104b/106b. As shown, the end electrodes 104c, 106c of each set 104, 106 allow for the introduction and/or removal of ions from the ELIT 100 along the central axis (A). Additionally, one or more of the inner electrodes 104d, 106d (e.g., adjacent detector 102) can be biased to act as an Einzel lens, thereby radially focusing the oscillating ion beam, for example, through the detector tube 102.

With reference now to FIG. 3, the ELIT 100 of FIG. 2 is depicted in a first configuration in accordance with various aspects of the present teachings in which the controller 193 controls the one or more voltage sources 197 and/or one or switches 198 to apply potentials to the electrodes of the first and second set 104, 106 such that a group of injected ions 15 are trapped between the electrodes 104a and the electrodes 106a of the inner, first group 104a/106a (the controller 193, voltage source(s) 197, and switch(es) 198 are not shown in FIG. 3 for clarity). As discussed in detail below and will be appreciated skilled in the art in light of the present teachings, the electrostatic potential applied to each electrode plate of the first group 104a/106a can be controlled so as to provide for trapping of the ions 15 therein. As shown schematically in FIG. 3, ions 15 are injected axially through end electrode 104c (also referred to herein as an ion inlet) and oscillate axially between the first set of electrodes 104 and the second set of electrodes 106 along path 115 having a path length L₁, for example. Detector 102 can be used to measure an induced image charge or current produced by the ions 15 oscillating along path 115. In various embodiments, one or more plates of the second group 104b/106b can be used to focus the ions 15, e.g., during their injection into, or ejection from, the ELIT 100.

The electrode plates of the first group 104a/106a can have a variety of configurations for trapping ions in the ELIT 100 in accordance with various aspects of the present teachings. Though the first group 104a/106a is depicted in FIG. 3 as comprising ten electrode plates (e.g., group 104a/106a comprises plates 104a₁₋₅ and 106a₁₋₅), it will be appreciated that the group 104a/106a can comprise any number of plates effective to trap ions in accordance with the present teachings. In certain aspects, as discussed otherwise herein, the potentials applied to the various plates of the first group 104a/106a can be effective to define the particular turning points and oscillation path length for the injected ions 15 within the ELIT 100. In certain aspects, at least one trapping plate and a minimum of three plates are used for changing the curvature of the electric field near each turning point (e.g., where the direction of ion oscillation is reversed) and radially confining ions throughout their procession of the trap. As a result, the first group 104a/106a can include at least four plates from the first set 104 and at least four plates from the second set 106. In various aspects, fewer electrodes may be used in each group if the electrodes are shaped, for example (i.e., they are not represented by a cylindrical structure as discussed above with respect to Hogan et al.). However, as depicted in FIG. 3 by way of non-limiting example, the electrodes 104a of the first group 104a/106a comprise one or more trapping plates 104a₁ (e.g., substantially defining the left end point or turning point of the oscillation of ions 15), one or more plates 104a₂₋₄ to change the curvature of the electric field near the turning point, and one or more plates 104a₅ to radially confine the ions 15. Likewise, the opposed electrodes 106a of the first group 104a/106a can comprise one or more trapping plates 106a₁ (e.g., substantially defining the right turning point), one or more plates 106a₂₋₄ to change the curvature of the electric field near the turning point, and one or more plates 106a₅ to radially confine the ions 15. It will be appreciated by the skilled artisan in light of the present teachings that the potentials applied to the electrodes 104a and each corresponding electrode 106a of the group 104a/106a, for example, can be controlled so at to provide one or more of trapping, changing the curvature of the electric field, and radially confining the ions 15 as they oscillate between the turning points. In certain aspects, for example, plates 104a₁/106a₁ may be configured as the trapping plate defining the turning point for the oscillation of ions 15 because the potentials applied to the such plates exceed the kinetic energy of the ions 15 injected into the ELIT 100. The potentials applied to the corresponding plates (e.g., 104aₙ and 106aₙ) in the first group 104a/106a and/or the position of the corresponding plates in the first group 104a/106a relative to the center of this group can be the same or different. In some example embodiments, the corresponding plates (e.g., 104aₙ and 106aₙ) of the first group 104a/106a can be positioned an identical distance from the detector 102 and/or can be controlled to have identical potentials applied thereto when trapping the ions 15 as shown in FIG. 3.

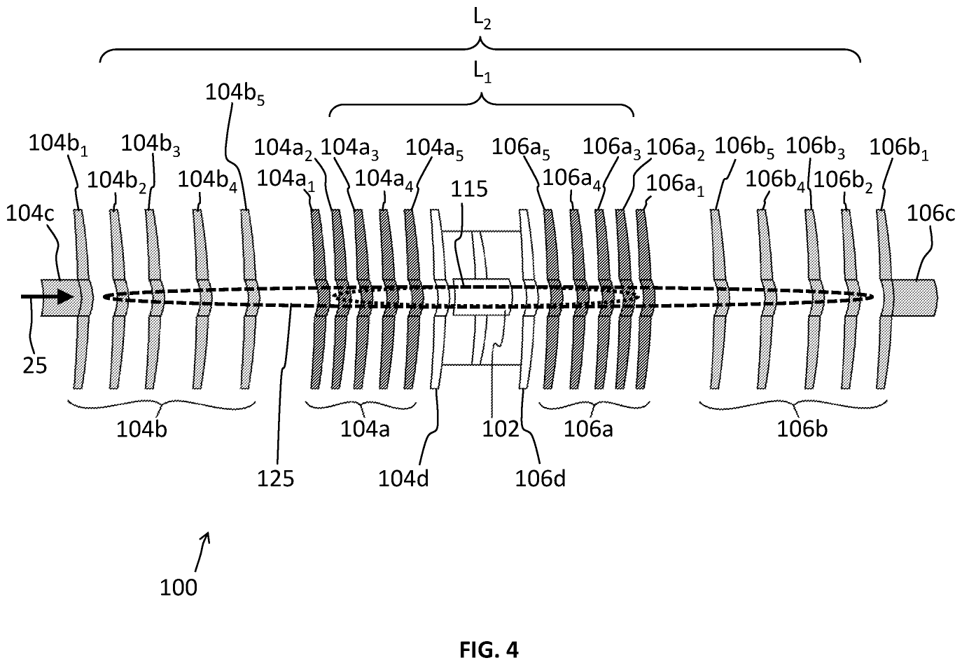

With reference now to FIG. 4, the ELIT 100 is depicted in a configuration in accordance with various aspects of the present teachings in which the controller 120 controls the one or more voltage sources 140 and/or one or switches 160 to apply potentials to the electrodes of the first and second set 104, 106 such that a second group of injected ions 25 exhibiting a different injection kinetic energy from the first group of ions 15 are simultaneously trapped by the electrodes 104b, 106b of the outer group 104b/106b while the first group of ions 15 continues to oscillate along path 115 having a path length L₁ as in FIG. 3. In particular, the controller 102 causes the potentials applied to each electrode plate 104b, 106b of the second outer group 104b/106b to be adjusted for trapping a second group of ions 25 along a second path 125 having a path length L₂. Again, detector 102 can be used to measure an induced image charge or current produced by the ions 25 oscillating along path 125.

The electrode plates of the group 104b/106b can also have a variety of configurations for trapping ions in the ELIT 100 in accordance with various aspects of the present teachings, and can comprise the same or different number of plates as the other group 104a/106a. As shown, however, the plates 104b of the group 104b/106b can comprise one or more trapping plates 104b₁ (e.g., substantially defining the left turning point), one or more plates 104b₂₋₄ to change the curvature of the electric field near the turning point, and one or more plates 104b₅ to radially confine the ions 25. Likewise, the plates 106b of the group 104b/106b can comprise one or more trapping plates 106b₁ (e.g., defining the right turning point), one or more plates 106b₂₋₄ to change the curvature of the electric field near the turning point, and one or more plates 106b₅ to radially confine the ions 25. Moreover, it will be appreciated that the potentials applied to each plate 104b and corresponding plate 106b (e.g., 104bₙ and 106bₙ) of the group 104b/106b can be controlled so at to provide one or more of trapping, changing the curvature of the electric field, and radially confining the ions 25 as they oscillate between the turning points of the group 104b/106b. For example, in certain aspects, plates 104b₁/106b₁ may be configured as the trapping plate defining the turning point for the oscillation of ions 25 because the potentials applied to the such plates exceed the kinetic energy of the ions 25 injected into the ELIT 100. The potentials applied to the corresponding plates (e.g., 104bₙ and 106bₙ) in the group 104b/106b and/or the position of the corresponding plates in the group 104b/106b relative to the center of this outer group can be the same or different. In some example embodiments, the corresponding plates (e.g., 104bₙ and 106bₙ) of the group 104b/106b can be positioned an identical distance from the detector 102 and/or can be controlled to have identical potentials applied thereto when trapping the ions 25 as shown in FIG. 4.

In this manner, various aspects of the present teachings provide for the simultaneous application of trapping potentials to both the first group 104a/106a and the second group 104b/106b such that the ELIT 100 can trap of a first group of ions 15 within a first kinetic energy range within the inner group 104a/106a of the ELIT 100 as shown in FIG. 3, and simultaneously, trap a second group of ions 25 within a second kinetic energy range within the outer group 104b/106b. For example, the first group of ions 15 can be injected axially through end electrode 104c and oscillate axially along path 115 having a path length L₁. During this injection, for example, the controller 193 can cause voltages to be applied to the second group 104b/106b to aid in radial focusing of the ions. With the first group of ions 15 trapped along the path 115 between trapping plate 104a₁ and trapping plate 106a₁ of the first group 104a/106a, the potentials applied to the electrodes of the second group 104b/106b can, in some aspects, be adjusted without substantially affecting the electric field generated along the first path length L₁ and/or without substantially affecting the oscillation of the first group of ions 15 along the first path 115. That is, following the injection of the first group of ions 15, the controller can adjust the potentials applied to the second outer group 104b/106b of electrodes such that the second group of ions 15 can be injected axially through end electrode 104c and oscillate axially along path 125 having a path length L₂. That is, two different groups 15, 25 of ions may be simultaneously trapped within the ELIT 100 along two different path lengths L₁, L₂. As shown, the configuration of the ELIT 100 in FIG. 4 thus provides a path length L₂ that is much longer than the path length L₁ such that the two groups of ions 15, 25 exhibit substantially different turning points. In particular, the plates 104a₁, 106a₁ of the first group of electrodes 104/106 represent the turning point for the first group of ions 15 while the plates 104b₁, 106b₁ represent the turning points for the second group of ions 25 with the turning point for each group being based in part on the kinetic energy of the injected ions.

It will further be appreciated in light of the present teachings, for example, that the controller 193 can be operably coupled to one or more ion traps (e.g., Q1 110, Q3 114, a segmented ion trap) or other ion control element known in the art or hereafter developed for transmitting ions into the ion inlet (104c), the controller configured to control the timing and kinetic energy of ion injection. For example, the injection kinetic energy of the second group of ions 25 may be greater than the injection kinetic energy of the first group of ions 15 such that the second group 25 of ions may be injected with and be maintained with sufficient energy to overcome the barrier posed by inner trapping plates 104a₁, 104b₁ configured to trap the first group of ions 15 exhibiting a lower injection kinetic energy.

It will be appreciated in light of the present teachings that the selection of potentials applied to particular electrode plates of the ELIT 100 can further enable various groups of electrodes to be selected among sets 104, 106 to generate additional ion paths of various lengths, thus allowing a single ELIT to fit the needs of different analyses. By way of non-limiting example, the potentials applied to plates 104b₅ and 106b₅ of FIG. 4 could be adjusted such that these plates represent trapping plates serving as the endpoints of ion oscillation, while the potentials applied to plates 104a₁ and 106a₁ could be set so as to change the curvature of the electric field near the turning point. Moreover, it will be appreciated that the present teachings also provide that one or more additional nested groups of electrodes can be provided (e.g., adding another inner or outer group), thereby allowing for trapping of ions along one or more additional paths having longer or shorter path lengths than L₁ and/or L₂ to accommodate additional group of ions injected at different injection kinetic energies.

The ions of the first and second groups 15, 25 can be analyzed in various manners in accordance with the present teachings. By way of example, in some aspects, the ELIT 100 may provide for the simultaneous analysis of ions of the first and second groups 15, 25 oscillating along their respective path lengths L₁, L₂. In such cases, the charge induced on the central detector 102 can reflect the oscillation of both groups of ions, which can then be used to determine the various m/z of ions in both the first and second groups 15, 25. Moreover, as discussed above, another detector (e.g., one or more of the electrodes of the second group 104b/106b) can be utilized to particularly measure the charge induced by the oscillation of the second group 25 along the second path 125 in order to separate the analysis of the second ion group 25 (e.g., the first group 15 would not induce a charge on such a detector disposed outside of its path 115). In such a case, the signal of the first group of ions may be obtained by subtracting the signal from the secondary detector from that of the central detector.

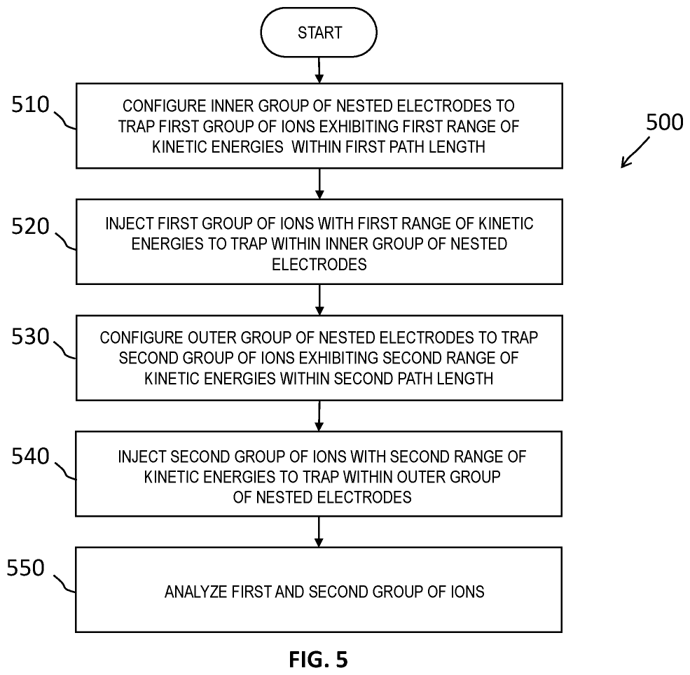

With reference now to FIG. 5, a flowchart showing an exemplary method 500 for operating an ELIT in accordance with various aspects of the present teachings is depicted. In step 510 of method 500, a nested ELIT like that shown in FIG. 2 can be configured to trap a first group of ions within the inner group of nested electrodes along a first path exhibiting a first path length. For example, a controller can cause one or more power supplies to apply trapping potentials to the inner group of nested electrodes. Thereafter, in step 520, the first group of ions can be injected with a first kinetic energy range substantially corresponding to the that trapping potentials applied to the inner group such that the ions are trapped within the inner group of nested electrodes and oscillate along the first path length. For example, a controller can cause an upstream ion processing element to release or transmit the first group of ions for injection into the ELIT such that the first group of ions exhibit a first range of kinetic energies.

Following injection and trapping of the first group of ions, the potentials applied to the outer group of nested electrodes can be adjusted in step 530 so as to configure the ELIT to trap a second group of ions therein along a second path exhibiting a second path length. For example, a controller can cause one or more power supplies to apply trapping potentials to the outer group of nested electrodes. In step 540, the second group of ions can then be injected with a second kinetic energy range (e.g., a kinetic energy range greater than the first kinetic energy range) such that the second group of ions are and trapped within the outer group of nested electrodes and oscillate along the second path. For example, a controller can cause an upstream ion processing element to release or transmit the second group of ions for injection into the ELIT such that the second group of ions exhibit a second range of kinetic energies. In various aspects, the second range of kinetic energies may be greater than the injection kinetic energy of the first group of ions such that the second group has sufficient energy to overcome the barrier posed by the inner nested electrodes and can oscillate along the longer, second path length. In this manner, the two groups of ions may exhibit substantially different turning points such that ion density is reduced when the velocity of the ions is at a minimum, thereby reducing the impact of the space charge effect.

As discussed otherwise herein, the frequency of oscillation of each of the groups of ions along their respective path lengths can be detected and analyzed to determine the mass spectrum for each group of ions using one or more detectors. In some example aspects, the detection and analysis of the second group of ions can be detected separately (e.g., using a detector outside of the first path length) or can be detected by the same detector for detecting the charge induced by oscillation of the first group of ions (e.g., central pickup electrode 102 of FIG. 2). In some aspects, the injection kinetic energies and the potentials applied to the various electrodes of the inner and outer nested groups can be selected such that the ions preferentially exhibit time-focusing at a central pickup electrode.

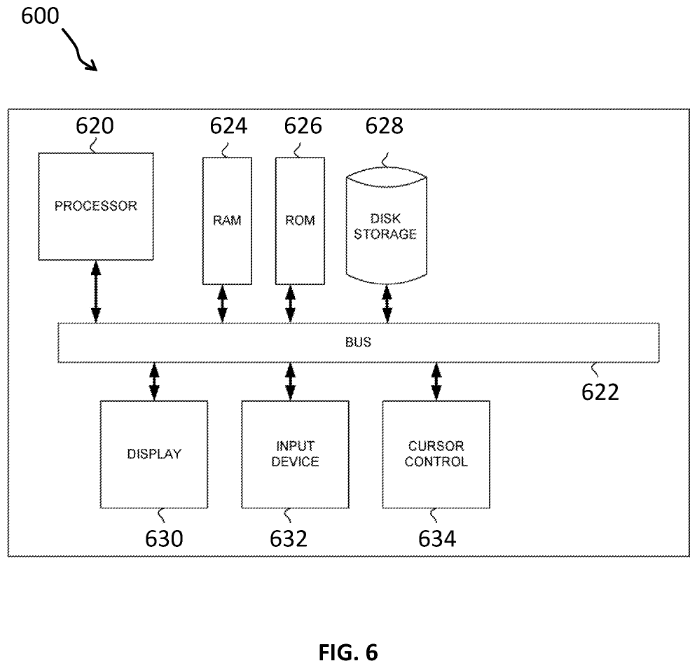

FIG. 6 is a block diagram that illustrates a computer system 600, upon which embodiments of the present teachings may be implemented. Computer system 600 includes a bus 622 or other communication mechanism for communicating information, and a processor 620 coupled with bus 622 for processing information. Computer system 600 also includes a memory 624, which can be a random access memory (RAM) or other dynamic storage device, coupled to bus 622 for storing instructions to be executed by processor 620. Memory 624 also may be used for storing temporary variables or other intermediate information during execution of instructions to be executed by processor 620. Computer system 600 further includes a read only memory (ROM) 626 or other static storage device coupled to bus 622 for storing static information and instructions for processor 620. A storage device 628, such as a magnetic disk or optical disk, is provided and coupled to bus 622 for storing information and instructions.

Computer system 600 may be coupled via bus 622 to a display 630, such as a cathode ray tube (CRT) or liquid crystal display (LCD), for displaying information to a computer user. An input device 632, including alphanumeric and other keys, is coupled to bus 622 for communicating information and command selections to processor 620. Another type of user input device is cursor control 634, such as a mouse, a trackball or cursor direction keys for communicating direction information and command selections to processor 620 and for controlling cursor movement on display 630. This input device typically has two degrees of freedom in two axes, a first axis (i.e., x) and a second axis (i.e., y), that allows the device to specify positions in a plane.

A computer system 600 can perform the present teachings. Consistent with certain implementations of the present teachings, results are provided by computer system 600 in response to processor 620 executing one or more sequences of one or more instructions contained in memory 624. Such instructions may be read into memory 624 from another computer-readable medium, such as storage device 628. Execution of the sequences of instructions contained in memory 624 causes processor 620 to perform the process described herein. Alternatively, hard-wired circuitry may be used in place of or in combination with software instructions to implement the present teachings. Thus, implementations of the present teachings are not limited to any specific combination of hardware circuitry and software. For example, the present teachings may be performed by a system that includes one or more distinct software modules for perform a method for operating an ELIT in accordance with various embodiments (e.g., a control module, an injection module, a FT module).

In various embodiments, computer system 600 can be connected to one or more other computer systems, like computer system 600, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 620 for execution. Such a medium may take many forms, including but not limited to, non-volatile media, volatile media, and transmission media. Non-volatile media includes, for example, optical or magnetic disks, such as storage device 628. Volatile media includes dynamic memory, such as memory 624. Transmission media includes coaxial cables, copper wire, and fiber optics, including the wires that comprise bus 622.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 620 for execution. For example, the instructions may initially be carried on the magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector coupled to bus 622 can receive the data carried in the infra-red signal and place the data on bus 622. Bus 622 carries the data to memory 624, from which processor 620 retrieves and executes the instructions. The instructions received by memory 624 may optionally be stored on storage device 628 either before or after execution by processor 620.

The descriptions herein of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software, though the present teachings may be implemented as a combination of hardware and software or in hardware alone. The present teachings may be implemented with both object-oriented and non-object-oriented programming systems.

In various aspects, the present teachings also provide methods for designing and/or optimizing the operation of ELITs to reduce the impact of the space charge effect when providing for the simultaneous analysis of various groups of ions injected into the ELIT at various injection energies. In certain aspects, for example, a mathematical model ELIT can initially be generated to define an initial spacing between reflectrons and calculate an initial electric potential applied to each reflectron so as to provide time focusing across a range of kinetic energies at the center of the ELIT. The mathematical model ELIT can contain any number, shape, and/or configuration of reflectrons, for example. Alternatively, the present teachings alternatively provide for the modeling of a previously-constructed ELIT.

A mathematical model of an ELIT was generated, the model defined to have a plurality of reflectrons, an Einzel lens, and a field free region in order to output theoretical voltages to apply to the reflectrons to provide time focusing across a range of kinetic energies at the center of the ELIT. Example inputs to the model included the thickness of the reflectrons and the gaps therebetween, the length of the field free region, the Einzel lens voltages and dimensions, an example ion mass, and the desired lowest kinetic energy one would like to focus. Defining the ion mass to be 500 Da, the lowest kinetic energy to be 500 eV, the length of the field free region to be 25.4 mm, the Einzel lens to have a length of 5.08 mm and be maintained at −2300 V, a 5.08 mm gap between the Einzel lens and the innermost reflectron, the reflectron thickness to be 0.635 mm, and the reflectrons separated by 1.27 mm, Table 1 below provides the electric potential to apply to each reflectron to satisfy the time-focusing criterion within an ELIT having infinitely thin 100% transmission grids, as shown in FIG. 7 (e.g., to provide time focusing at the center of the ELIT regardless of the ions kinetic energy).

TABLE 1

| Distance | Mathematical | Distance | Mathematical |
|---|---|---|---|
| from trap | Solution | from trap | Solution |
| center (mm) | (V) | center (mm) | (V) |
| 42.8625 | 500.000 | 58.1025 | 1535.494 |
| 44.7675 | 628.362 | 60.0075 | 1680.062 |
| 46.6725 | 750.992 | 61.9125 | 1829.044 |
| 48.5775 | 873.815 | 63.8175 | 1982.497 |
| 50.4825 | 998.910 | 65.7225 | 2140.465 |
| 52.3875 | 1127.200 | 67.6275 | 2302.979 |
| 52.2925 | 1259.218 | 69.5325 | 2470.062 |
| 56.1975 | 1395.254 | 71.4375 | 2641.732 |

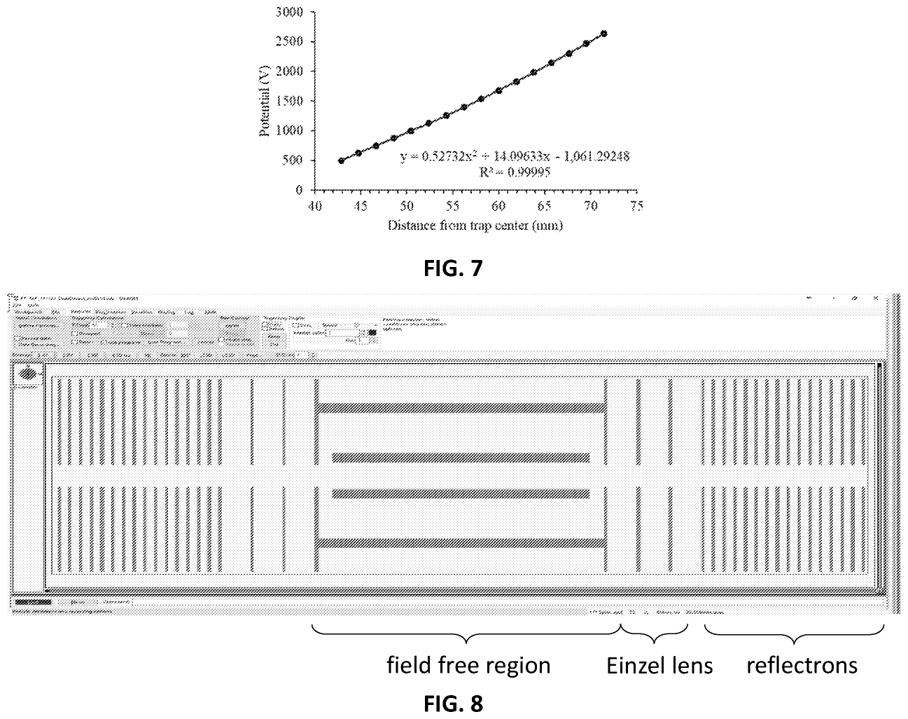

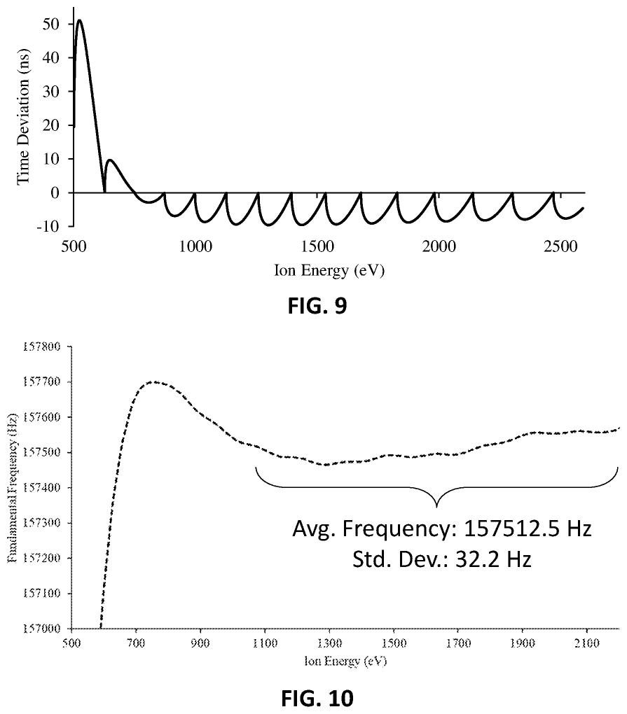

Utilizing the mathematical model discussed above, a virtual model was generated in SIMION® as shown in FIG. 8 to simulate the motion of ions within the virtual ELIT. As shown, the ELIT contains a field free central region, an Einzel lens (e.g., for focusing around the field free regions), and 16 reflectrons disposed on each side of the field free region with various features as defined in the mathematical model. FIG. 9 depicts the calculated deviation in the turn-around time within the SIMION model using the optimal potentials in Table 1 at steps of 1 eV for kinetic energies across the range of 500 eV to 2600 eV. It will be appreciated that time deviation goes to zero when the ion's kinetic energy corresponds to a plate potential, i.e., the ion turns around at the center of an infinitely thin 100% transmission grid. While time deviations across the range of ion kinetic energies are on the order of pico- to nano seconds, the many laps of ions within the ELIT may result in decoherence of an ion packet exhibiting a broad kinetic energy distribution.

Though the simulation of FIG. 9 provides a starting point for electrode potential optimization, it is recognized that the assumption of infinitely thin 100% transmission grids as used to generate the data of FIG. 9 does not hold true in the gridless reflectrons of an actual ELIT. The data presented in FIG. 10 was generated using the SIMION model of FIG. 9, modified to be gridless. In particular, FIG. 10 depicts the calculated frequency of an example ion m/z 500 flown along the model axis (i.e., with no radial kinetic energy) with the initially calculated potentials of Table 1 applied to the reflectrons. As shown by the non-horizontal nature of FIG. 10, the calculated frequency is kinetic-energy dependent, with the average frequency being 157512.5 Hz between injection energies of 1000 eV and 2200 eV and a standard deviation of 32.2 Hz across this range.

In accordance with various aspects of the present teachings, the potentials to apply to the reflectrons of the ELIT may be further optimized from the mathematical ideal solution presented in Table 1 above to further reduce the deviation of frequency across a broad range of injection energies. As discussed above with reference to the results of the gridless SIMION® simulation of FIG. 10, the calculated average frequency is 157512.5 Hz between injection energies of 1000 eV and 2200 eV (standard deviation of 32.2 Hz) when the initially calculated simulated electric potentials of Table 1 are applied to the model reflectrons of FIG. 8. However, in a case in which the 32.2 Hz standard deviation is outside of a desired threshold across a desired kinetic energy range, the electric potentials applied to the model reflectrons may be further optimized until the frequency deviation for an ion or plurality of ions is within the desired range. By way of example, an optimization process (e.g., a Nelder-Mead downhill simplex optimization of SIMION) was performed with the following conditions: 1000 iterations, run 5 times through (best solution of the previous run used as the starting point for the following run), 2V initial step, 14 ions across a KE range of 900-2200 eV in 100 eV increments. The final optimized potentials are shown in Table 2.

TABLE 2

| Distance | Table 1 | Optimized | |
|---|---|---|---|
| from trap | Mathematical | Simulation | Difference |
| center (mm) | Solution (V) | (V) | (V) |
| 42.8625 | 500.000 | 500.405 | 0.405 |
| 44.7675 | 628.362 | 628.300 | −0.062 |
| 46.6725 | 750.992 | 750.080 | −0.912 |
| 48.5775 | 873.815 | 873.427 | −0.388 |
| 50.4825 | 998.910 | 998.390 | −0.511 |
| 52.3875 | 1127.200 | 1127.272 | 0.072 |
| 52.2925 | 1259.218 | 1259.362 | 0.144 |
| 56.1975 | 1395.254 | 1396.370 | 1.116 |
| 58.1025 | 1535.494 | 1535.791 | 0.297 |
| 60.0075 | 1680.062 | 1681.243 | 1.181 |
| 61.9125 | 1829.044 | 1829.852 | 0.808 |
| 63.8175 | 1982.497 | 1982.792 | 0.295 |
| 65.7225 | 2140.465 | 2141.077 | 0.612 |
| 67.6275 | 2302.979 | 2303.262 | 0.283 |
| 69.5325 | 2470.062 | 2469.978 | −0.084 |
| 71.4375 | 2641.732 | 2640.636 | −1.096 |

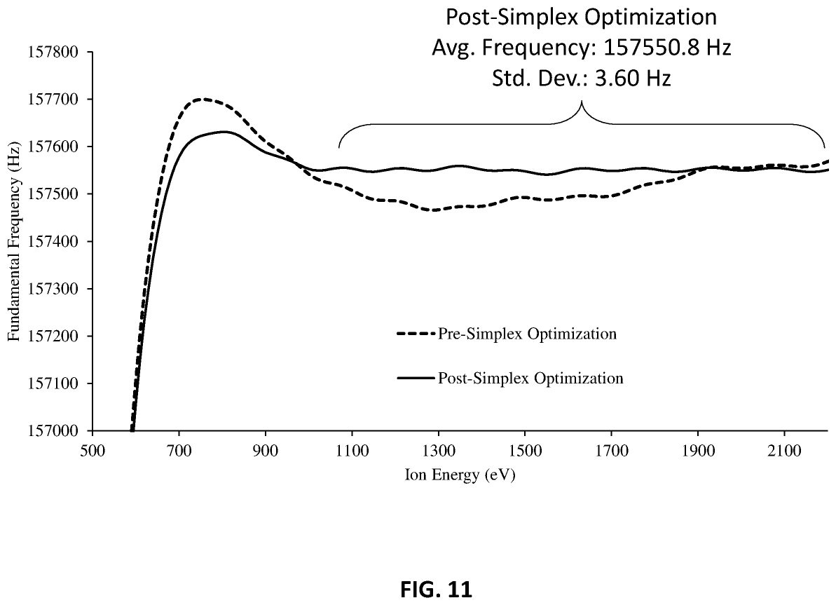

FIG. 11 depicts the calculated frequency from FIG. 10 (i.e., Pre-Simplex Optimization using the theoretical electric potentials of Table 1), as well as the calculated frequency for the same example ion m/z 500 flown along the model axis (i.e., with no radial kinetic energy) with the Post-Simplex calculated potentials of Table 2 applied to the reflectrons. As shown, the Post-Simplex optimized potentials resulted in a substantially horizontal plot for injection energies between 1000 eV and 2200 eV, with the average frequency being 157550.8 Hz and a standard deviation of 3.60 Hz across this range. The standard deviation across the range of 1000 eV and 2200 eV injection energies following the example optimization is almost a factor of ten better than the deviation obtained in FIG. 10 when using the theoretical potentials of Table 1. It will be appreciated that fewer or more optimization iterations could have been performed depending on a desired threshold across a desired kinetic energy range. Moreover, though the data above are discussed with reference to reducing and/or optimizing deviations in frequency across a range of kinetic energies (e.g., a range of 1000 eV-2200 eV), it will be appreciated that specific ion kinetic energies may be alternatively provided to the optimization process to instead optimize specific frequencies, for example.

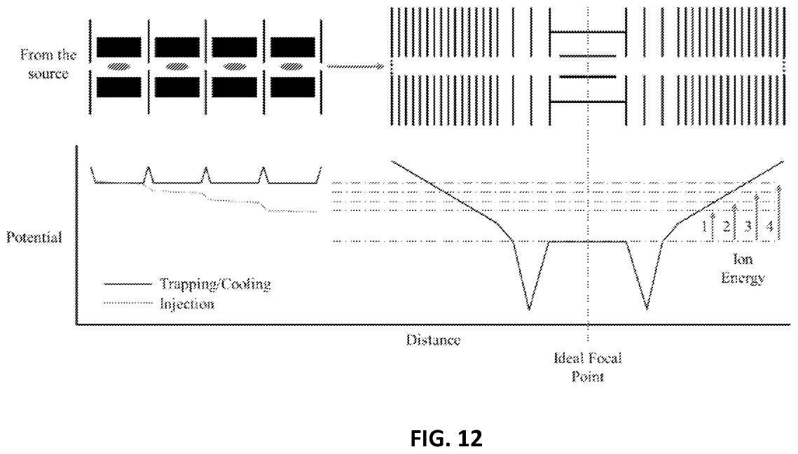

An example system and method of ion injection in accordance with various aspects of the present teaching is schematically depicted in FIG. 12. As shown, the segmented ion trap is configured to serially release four groups of ions trapped within each segment such that they arrive at the ELIT at four different kinetic energies. Because each group of ions exhibit different kinetic energies relative to the other groups, each group will turn around at different reflectrons within the ELIT, thereby minimizing charge density at the various turning points relative to a system in which all ions are injected with substantially identical injection energies. Additionally, in accordance with the optimization routines discussed above, for example, the particular injection energies may be chosen to substantially correspond to four of the optimized reflectron potentials in Table 2 to provide for time-focusing of the four groups of ions within the ELIT.

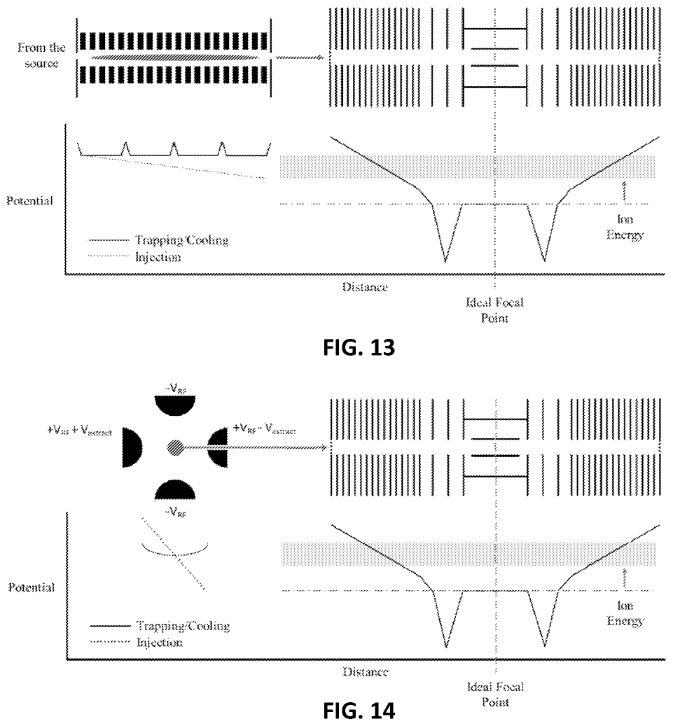

Upon performing the example optimization discussed above, it will be appreciated that the reduced frequency deviation may provide improved time focusing across a broad range of injection energies. In such aspects, groups of ions may substantially achieve time focusing at different turn around points in an actual ELIT having the optimized potentials applied thereto, substantially regardless of whether the groups of ions are injected at particular frequencies or a range of frequencies. By way of example, in addition to the injection strategy discussed above with reference to the schematic of FIG. 12 in which groups of ions are particularly ejected at selected injection energies, groups of ions may instead be injected across a range of kinetic energies as depicted in the schematic of FIG. 13 under low resolution conditions. As shown, the potential applied to the exit lens on an upstream may be lowered substantially continuously (e.g., as opposed to stepwise as in the segmented ion trap of FIG. 12) such that ions are released toward the ELIT as their kinetic energy overcomes the decreasing exit barrier. Under low resolution conditions (e.g. short transients, high m/z), it may be possible to use any ion energy to achieve the required level of precision in mass accuracy, intensity, etc. when using a broad kinetic energy trap. For example, in the plot of FIG. 11, all frequencies are within 20 Hz of the average frequency 157550.8 Hz over the kinetic energy range of 1000 eV to 2200 eV. To achieve such frequency resolution (˜7900), one would need an m/z resolution of 3950 @ m/z 500, which has a fundamental frequency of ˜157550 Hz and would require a transient length of at least 50 ms, assuming that no ion decay occurs. If making measurements at 100 Hz (T₀=10 ms), for example, any ion energy in the range could be used where the ions are axially distributed along the quadrupole axis of FIG. 13 when the linear extraction field is applied.

Likewise, under such low resolution conditions, it will be appreciated that the present teachings also provide that ions may be radially extracted from a multipole even with high push/pull extraction voltages as depicted in FIG. 14. If, for example, the ion cloud diameter is 1 mm in a quadrupole with a r₀ of 4 mm, even V_{extract}=+/−1000V will impart a kinetic energy distribution of 250 eV (max−min).

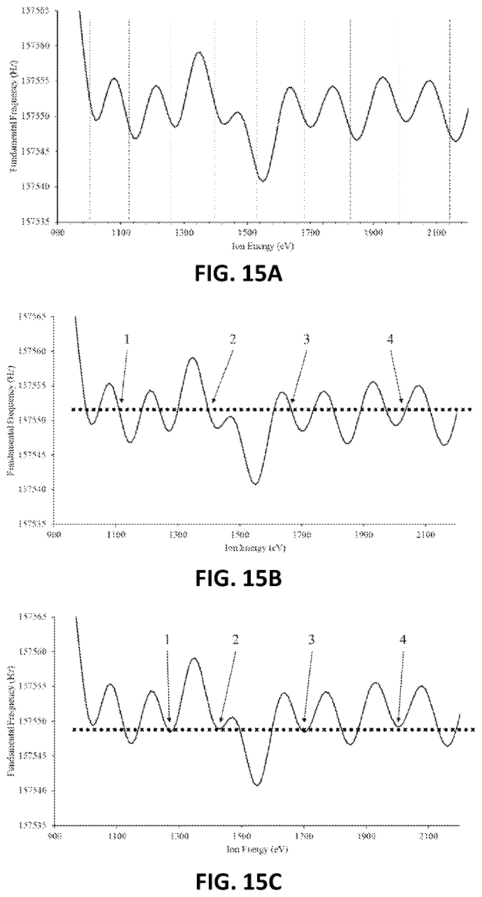

As opposed to the relatively low resolution ejection from upstream traps discussed above with reference to FIGS. 13 and 14, the present teachings also provide for even more particular selection of ion injection energies relative to the ion injection strategy of FIG. 12 to further minimize frequency differences in the ELIT. With reference now to FIGS. 15A-C, the post-simplex optimization of FIG. 11 is shown in additional detail with the y-axis of FIG. 15A-C ranging from 157535 Hz to 157565 Hz, with the vertical lines in FIG. 15A representing the optimized plate potentials of Table 2. While any four points on the curve of FIG. 15B at a given frequency may provide the injection energies for four groups of ions exhibiting reduced frequency deviation in accordance with various aspects of the present teachings (e.g., the dotted line represents a frequency of about 157552 Hz), it will be appreciated that the non-zero slope of the line at the four points of FIG. 15B indicate areas where the observed frequency is more dependent on the injected ion energy. Accordingly, in certain aspects, the mean injected ion energies may be preferentially chosen to be at or near crests or troughs (e.g., where the slope is substantially equal to zero) in order to further minimize frequency differences arising from position-dependent ion acceleration within the injection traps. As shown in FIG. 15C, for example, the selected injection energies may correspond to the four identified troughs to further tailor the simplex optimization in SIMION to match the frequencies of the chosen ion energies for improved time-focusing.

In light of the above, it will be appreciated that the exact ion energies may be chosen such that upon ion injection, ions of the same m/z preferably come to a time focus at the center of the downstream electrostatic trap. Further, a person skilled in the art will appreciate that the ejection energies may be selected (or adjusted) to account for any ion optical elements between the traps and the ELIT, for example. Likewise, the length of the individual traps and/or the distances between them could be optimized to bring ions to a time focus if the ion energies are specifically chosen. Moreover, it will be appreciated that one or more additional traps or optical elements may be additionally or alternatively provided in accordance with the present teachings to provide for the desired injection energy into the ELIT, including by way of non-limiting example, one or more traps having axial fields (e.g., segmented ion traps, auxiliary electrodes, etc.) to move the ions within the traps to achieve the time-focusing criterion.

A person skilled in the art will appreciate that the present teachings may not only be applied to a theoretical ELIT (e.g., an ELIT yet to be built), but also may be effective to optimize the performance of an actual, pre-existing ELIT through the selection of optimal potentials to be applied to the various electrodes of the ELIT and/or the upstream trap from which ions are ejected in order to minimize differences in the measured frequencies of the ions (e.g., using simplex optimization).

The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

What is claimed is:

1. A mass spectrometer system comprising:
an electrostatic linear ion trap (ELIT), comprising:
a first set of electrode plates having holes in the center and aligned along a central axis; and
a second set of electrode plates having holes in the center and aligned along the central axis, wherein a first group of plates of the first and second sets is positioned along the central axis to trap a first group of ions therebetween within a first path length along the central axis and wherein a second group of plates of the first and second sets is positioned along the central axis to simultaneously trap a second group of ions within a second path length of the central axis that is different than the first path length; and
one or more ion traps disposed upstream of the ELIT and configured to inject the first and second groups of ions therein, wherein the one or more ion traps are configured to inject the first group of ions into the ELIT within a first range of kinetic energy and to inject the second group of ions from the ion trap into the ELIT within a second range of kinetic energy, wherein the first and second ranges of kinetic energy are different.

2. The system of claim 1, wherein the first group of ions and the second group of ions exhibit substantially the same m/z range.

3. The system of claim 1, wherein ions of the same m/z in the first and second groups of ions arrive at a location between the first and second sets of electrode plates at substantially the same time during their respective oscillation along the first and second path lengths.

4. The system of claim 1, wherein the first range of kinetic energy is selected such that the first group of ions exhibits a first frequency of oscillation along the first path length and wherein the second range of kinetic energy is selected such that the second group of ions exhibits a second frequency of oscillation along the second path length.

5. The system of claim 4, wherein the first and second frequencies of oscillation are substantially identical.

6. The system of claim 1, wherein a third group of plates of the first and second sets is positioned along the central axis to trap a third group of ions therebetween within a third path length along the central axis that is different than the first and second path lengths, and wherein said one or more ion traps are configured to inject the third groups of ions into the ELIT within a third range of kinetic energy that is different than the first and second ranges of kinetic energy.

7. The system of claim 6, wherein a fourth group of plates of the first and second sets is positioned along the central axis to trap a fourth group of ions therebetween within a fourth path length along the central axis that is different than the first, second, and third path lengths, and wherein said one or more ion traps are configured to inject the fourth groups of ions into the ELIT within a fourth range of kinetic energy that is different than the first, second, and third ranges of kinetic energy.

8. The system of claim 7, wherein the first, second, third, and fourth groups of ions exhibit substantially the same m/z range.

9. The system of claim 1, further comprising a controller configured to:
adjust at least one of the first range of kinetic energy, the second range of kinetic energy, a potential applied to the first group of plates, and a potential applied to the second group of plates to minimize differences in an oscillation frequency of the first and second groups of ions along their respective first and second path lengths.

10. The system of claim 9, wherein the controller is further configured to:
adjust at least one of the first range of kinetic energy, the second range of kinetic energy, the potential applied to the first group of plates, and the potential applied to the second group of plates to minimize a difference in time at which ions of the same m/z in the first and second groups of ions arrive at a location between the first and second sets of electrode plates during oscillation of the first and second groups of ions along their respective first and second path lengths.

11. A method of analyzing ions comprising:
transmitting a first group of ions exhibiting a first range of kinetic energy and a second group of ions exhibiting a second range of kinetic energy different from the first range of kinetic energy from one or more ion traps to an electrostatic ion trap (ELIT), the ELIT comprising:
a first set of electrode plates having holes in the center and aligned along a central axis; and
a second set of electrode plates having holes in the center and aligned along the central axis;
trapping the first group of ions between a first group of plates of the first and second sets positioned along the central axis within a first path length along the central axis;
concurrent with trapping the first group of ions, trapping the second group of ions between a second group of plates of the first and second sets positioned along the central axis within a second path length along the central axis that is different than the first path length; and
detecting an electric current induced by the first group of ions oscillating along the first path length and the electric current induced by the second group of ions oscillating along the second path length.

12. The method of claim 11, wherein the first group of ions and the second group of ions exhibit substantially the same m/z range.

13. The method of claim 11, wherein ions of the same m/z in the first and second groups of ions arrive at a location between the first and second sets of electrode plates at substantially the same time during their respective oscillation along the first and second path lengths.

14. The method of claim 11, wherein the first range of kinetic energy is selected such that the first group of ions exhibits a first frequency of oscillation along the first path length and wherein the second range of kinetic energy is selected such that the second group of ions exhibits a second frequency of oscillation along the second path length.

15. The method of claim 14, wherein the first and second frequencies of oscillation are substantially identical.

16. The method of claim 11, wherein the ELIT further comprises:
a third group of plates of the first and second sets having holes in the center and aligned along the central axis; and
a fourth group of plates of the first and second sets having holes in the center and aligned along the central axis;
and wherein the method further comprises trapping a third group of ions exhibiting a third range of kinetic energy between the third group of plates defining a thrid path length and trapping a fourth group of ions exhibiting a fourth range of kinetic energy between the fourth group of plates defining a fourth path length.

17. The method of claim 11, further comprising adjusting at least one of the first range of kinetic energy, the second range of kinetic energy, a potential applied to the first group of plates, and a potential applied to the second group of plates to minimize differences in an oscillation frequency of the first and second groups of ions along their respective first and second path lengths.

18. The method of claim 17, further comprising adjusting at least one of the first range of kinetic energy, the second range of kinetic energy, the potential applied to the first group of plates, and the potential applied to the second group of plates to minimize a difference in time at which ions of the same m/z in the first and second groups of ions arrive at a location between the first and second sets of electrode plates during oscillation of the first and second groups of ions along their respective first and second path lengths.

19. A method of configuring an electrostatic ion trap (ELIT), comprising:
generating a model ELIT based on a physical ELIT comprising a first set of electrode plates having holes in the center and aligned along a central axis and a second set of electrode plates having holes in the center and aligned along the central axis;
determining an initial simulated electric potential respectively applied to each of a plurality of simulated electrodes of the model ELIT, wherein each of the plurality of simulated electrodes represents one of the first set of electrode plates and the second set of electrode plates;
simulating an injection of a simulated ion at a plurality of kinetic energies into the model ELIT in which the initial simulated electric potentials are respectively applied to each of the plurality of simulated electrodes;
for each of the plurality of kinetic energies, determining the predicted frequency of oscillation of said simulated ion between at least two of the plurality of simulated electrodes of the model ELIT;
determining whether the predicted frequency of oscillation for said simulated ion at each of the plurality of kinetic energies is within a predefined range of the average predicted frequency of oscillation across the plurality of kinetic energies;
in a case in which the predicted frequency of oscillation for said simulated ion at each of the plurality of kinetic energies is within the predefined range:
configuring the physical ELIT such that each of the electrode plates of the first and second sets corresponding to each of the plurality of simulated electrodes have said initial simulated electric potential respectively applied thereto; and
in a case in which the predicted frequency of oscillation for said simulated ion for at least one of the plurality of kinetic energies is outside of the predefined range:
iteratively adjusting the simulated electric potential applied to one or more of the plurality of simulated electrodes of the model ELIT until the predicted frequency of oscillation for said simulated ion at each of the plurality of kinetic energies is within the predefined range of the average predicted frequency of oscillation across the plurality of kinetic energies; and
configuring the physical ELIT such that each of the electrode plates of the first and second sets corresponding to the each of the plurality of simulated electrodes of the model ELIT have said adjusted simulated electric potential respectively applied thereto.

20. The method of claim 19, further comprising:
injecting at least a first group of ions and a second group of into the physical ELIT, wherein each of the first and second groups of ions exhibit a different injection kinetic energy; concurrently trapping the first group of ions between a first group of plates of the first and second sets within a first path length along the central axis and the second group of ions between a second group of plates of the first and second sets positioned within a second path length along the central axis that is different than the first path length.
